(19) United States
(12) Patent Application Publication
(10) Pub. No.: US 2025/0361401 A1
(43) Pub. Date: Nov. 27, 2025

(54) REACTIVE DYES

(71) Applicant: Alcon Inc., Fribourg (CH)

(72) Inventors: Troy Vernon Holland, Suwanee, GA (US); Richard Charles Breitkopf, Dunwoody, GA (US); Frank Chang, Cumming, GA (US)

(21) Appl. No.: 19/214,136

(22) Filed: May 21, 2025

Related U.S. Application Data
(60) Provisional application No. 63/650,762, filed on May 22, 2024.

(51) Int. Cl. C09B 62/04; B29D 11/00; B29K 83/00; C08F 8/30; C08F 8/34; C09B 62/085; G02B 1/04

(52) U.S. Cl. CPC C09B 62/046; B29D 11/00125; B29D 11/00923; C08F 8/30; C08F 8/34; C09B 62/085; G02B 1/043; B29K 2083/00

(57) ABSTRACT

The present invention is related to reactive dyes each of which comprises a dichlorotriazine or chlorotriazine group and has a desired UV/visible absorption spectrum for selectively filtering a certain color light. They are suitable for method for producing colored silicone hydrogel contact lenses each made of a silicone hydrogel material having hydroxyl groups. The present invention is also related to a colored silicone hydrogel contact lens comprising a colored annular ring and/or a colored circular area in which a reactive dye is applied and thereby covalently attached.

This invention is related to reactive dyes each having a dichlorotriazine group, which are useful for selectively coloring a desired portion of a contact lens having hydroxyl groups covalently attached to its polymer matrix. This invention also provides a method for making a reactive dye of the invention.

### BACKGROUND

A great effort has been made to develop ophthalmic lenses, such as, spectacles, contact lenses, intraocular lenses, etc., capable of filtering high-energy-violet-light (HEVL) (380-450 nm) so as to protect eyes from increasing exposures of HEVL due to widely use of LED lights and LED displays, e.g., smart phone, TV and computer monitor (see, e.g., U.S. Pat. Nos. 4,612,358, 4,528,311, 4,716,234, 4,878,748, 5,400,175, 5,662,707, 6,158,862, 6,955,430, 7,556,376, 7,803,359, 8,153,703, 8,232,326, 8,360,574, 8,585,938, 8,882,267, 9,377,569, 9,683,102, 9,814,658, 10,268,053, 10,526,296, 10,551,637, 10,610,472, 10,723,732, 10,752,720, 10,935,695, 11,046,636, 11,066,530, and 11,493,668; U.S. Pat. Appl. Pub. Nos. 20200407324 and 20200407337). There are also a great of interests in selectively filtering certain color lights, e.g., blue and/or red lights.

TOTAL30® (from Alcon) is the first contact lens to offer HEVL-filtering capability that is constantly in effect while wearing the lenses regardless of the lighting conditions. TOTAL30® not only includes Class I UV absorption for protection against UVA and UVB rays (i.e., filtering more than 90% UVA and 99% UVB rays), but also can filter out approximately 33% of HEVL rays entering the eye (between 380-450 nm). Alcon subsequently launched a second product, TOTAL1®, which like TOTAL30® can block 90% UVA, 99% UVB, and 33% HEVL. Johnson & Johnson Vision Care recently also launched ACUVUE® OASYS MAX 1-DAY which can block up to 45% HEVL according to its published 510(k) Premarket Notification (K210930).

However, when HEVL-filtering contact lenses are obtained by cast-molding of a polymerizable composition including polymerizable HEVL-absorbing compound (i.e., a polymerizable dye) according to the conventional cast-molding technique, it often found that those polymeriable dyes are susceptible to free-radical-induced degradation during the polymerizable composition in lens molds.

Moreover, such HEVL-filtering contact lenses inevitably have a yellow color from edge-to-edge of the contact lenses and thereby would not be aesthetically pleasing on the wearer's eye. A blue-tinting agent is generally required to hide the unappealing yellow color to some extend. The edge-to-edge yellowish coloring could limit the amount of HEVL-filtering compound to be incorporated in a contact lens, thereby limiting its HEVL-filtering capability.

U.S. Pat. Nos. 4,468,229, 4,553,975, 4,559,059, 4,954,132 and 4,891,046 disclose a method for making edge-to-edge tinted contact lenses involving immersing a preformed contact lens in a tinting solution (containing a dye).

It would be desirable to use a reactive dye to selectively color a portion of lens within the central circular region of a contact lens. The central circular region of a contact lens covers (overlays) the iris of an eye when the contact lens is worn on the eye. Such a centrally colored contact lens not only can be aesthetically pleasing on the wearer's eye but also can have a high capability of selectively filtering a desired color light (e.g., HEVL, red, blue, or the like) without limit of the amount of color-filtering compound to be incorporated therein.

It would be also desirable to have reactive dyes suitable for coloring a limited portion of a contact lens for having a high capability of filtering selectively a color light with a desired range of wavelengths.

### SUMMARY

The invention, in one aspect, provides a reactive dye having at least one dichlorotriazine group of any one of formula (1), (2) and (3)

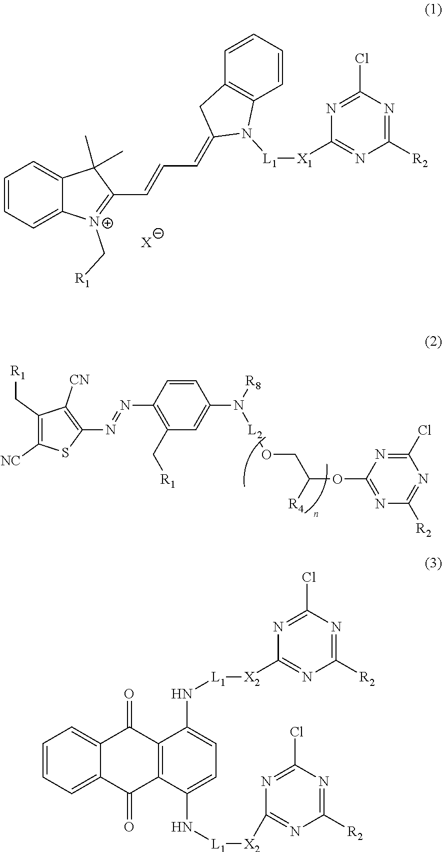

in which: X is a negatively-charged counter ion (preferably I, Br, Cl, R₃COO⁻, R₃SO₃⁻ or Bis(oxalate)borate) or a negatively charged group of R₁; R₁ is H or a C₁-C₁₀ alkyl which is optionally substituted with one or more functional groups selected from the group consisting of OH, OCH₃, OC₂H₅, COOH, COOR₅, NR₆R₇, SO₃⁻, and combinations thereof (preferably H); R₂ is H or Cl (preferably Cl); R₄ is H or CH₃; R₃ and R₅ independent of each other are a C₁-C₄ alkyl; R₆ and R₇ independent of each other are H or a C₁-C₄ alkyl; L₁ is a C₂-C₁₀ alkylene divalent radical or a divalent radical of

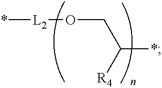

L₂ independent of each other are a C₂-C₁₀ alkylene divalent radical; R₈ is a C₁-C₁₀ alkyl which is optional substituted with one or more functional groups selected from the group consisting of OH, OCH₃, OC₂H₅, COOH, COOR₅, NR₆R₇, SO₃⁻, and combinations thereof or is a monovalent radical of

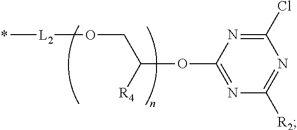

### X₁ is

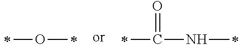

in which the nitrogen atom is connected to triazine; X₂ is *—O—* or

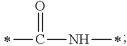

and n and m independent of each other are an integer of 1 to 10.

The invention provides, in another aspect, use of a reactive dye of the invention in making colored silicone hydrogel contact lenses.

The invention, in a further aspect, provides a colored silicone hydrogel contact lens, comprising (1) a polymer matrix having hydroxyl groups covalently attached thereonto; and (2) a colored annular ring and/or a colored central circular area both of which are located in a central circular region of the colored silicone hydrogel contact lens, wherein the central circular region has a diameter of about 9.0 mm or less (preferably about 8.5 mm or less, more preferably about 8.0 mm or less, even more preferably about 7.5 mm or less) wherein the colored annular ring and the colored central circular area independent of each other comprise at least one reactive dye of any one of claims 1 to 19 which is covalently attached onto the polymeri matrix through linkages formed between one hydroxyl group and a dichlorotriazine or chlorotriazine of the reactive dye, wherein the colored annular ring and the colored circular area are concentric with the central axis of the colored silicone hydrogel contact lens.

### BRIEF DESCRIPTIONS OF THE DRAWINGS

FIG. 1 shows the procedures for synthesizing a reactive dye of the invention according to a preferred embodiment.

FIG. 2 shows the procedures for synthesizing a reactive dye of the invention according to a preferred embodiment.

### DETAILED DESCRIPTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

“About” as used herein means that a number referred to as “about” comprises the recited number plus or minus 1-10% of that recited number.

“Optional” or “optionally” means that the subsequently described event or circumstance can or cannot occur, and that the description includes instances where the event or circumstance occurs and instances where it does not.

An “ophthalmic device”, as used herein, refers to a contact lens (hard or soft), an intraocular lens, a corneal onlay, other ophthalmic devices (e.g., stents, glaucoma shunt, or the like), or spectacles used on or about the eye or ocular vicinity.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens. A “silicone hydrogel contact lens” or “SiHy contact lens” refers to a contact lens comprising a silicone hydrogel material.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A “silicone hydrogel” or “SiHy” refers to a silicone-containing hydrogel obtained by copolymerization of a polymerizable composition comprising at least one silicone-containing monomer or at least one silicone-containing macromer or at least one crosslinkable silicone-containing prepolymer.

A “siloxane” or “silicone”, as known to a person skilled in the art, interchangeably refers to a moiety of —Si—O—Si— where each Si atom carries at least two substituents (organic groups) or a molecule having at least one moiety of —Si—O—Si—.

As used in this application, the term “non-silicone hydrogel” refers to a hydrogel that is theoretically free of silicon.

“Hydrophilic,” as used herein, describes a material or portion thereof that will more readily associate with water than with lipids.

A “vinylic monomer” refers to a compound that has one sole ethylenically unsaturated group, is soluble in a solvent, and can be polymerized actinically or thermally.

The term “soluble”, in reference to a compound or material in a solvent, means that the compound or material can be dissolved in the solvent to give a solution with a concentration of at least about 0.5% by weight at room temperature (i.e., a temperature of about 21° C. to about 27° C.).

The term “insoluble”, in reference to a compound or material in a solvent, means that the compound or material can be dissolved in the solvent to give a solution with a concentration of less than 0.01% by weight at room temperature (as defined above).

An “organic-base solution” refers to a solution that comprises at least 55% by weight of one or more organic solvent (i.e., that is formed by dissolving/blending a solute in an organic based solvent). It is understood that an organic based solution can comprise less than 45% by weight of water.

An “organic based solvent” refers to a solvent system comprising at least 55% by weight of one or more organic solvent.

An “aqueous solution” refers to a solution comprising at least 55% by weight of water. It is understood that an organic based solution can comprise less than 45% by weight of one or more organic solvents miscible with water.

The term “ethylenically unsaturated group” is employed herein in a broad sense and is intended to encompass any groups containing at least one >C═CH₂ group. Exemplary ethylenically unsaturated groups include without limitation (meth)acryloyl

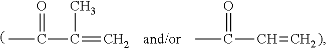

allyl, vinyl, styrenyl, or other C═C containing groups.

As used herein, “actinically” in reference to curing, crosslinking or polymerizing of a polymerizable composition, a prepolymer or a material means that the curing (e.g., crosslinked and/or polymerized) is performed by actinic irradiation, e.g., UV/visible light irradiation, or the like. Thermal curing or actinic curing methods are well-known to a person skilled in the art.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group (—CH═CH₂) that is directly attached to the nitrogen atom of the amide group.

A “hydrophilic vinylic monomer”, as used herein, refers to a vinylic monomer which can be polymerized to form a homopolymer that is water-soluble or can absorb at least 10 percent by weight of water.

A “hydrophobic vinylic monomer” refers to a vinylic monomer which can be polymerized to form a homopolymer that is insoluble in water and can absorb less than 10 percent by weight of water.

An “acrylic monomer” refers to a vinylic monomer having one sole (meth)acryloyl group.

An “acrylamido monomer” refers to a vinylic monomer having one sole (meth)acrylamido group

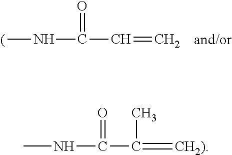

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

A “polysiloxane segment” or “polydiorganosiloxane segment” interchangeably refers to a polymer chain segment (i.e., a divalent radical) of

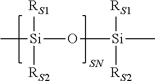

in which SN is an integer of 3 or larger and each of R_{S1} and R_{S2} independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)_{γ1}-OR^{o} (in which alk is C₁-C₆ alkylene diradical, R^{o} is H or C₁-C₄ alkyl and γ1 is an integer from 1 to 10); a C₂-C₄₀ organic radical having at least one functional group selected from the group consisting of hydroxyl group (—OH), carboxyl group (—COOH), amino group (—NR_{N1}R_{N1}′), amino linkages of —NR_{N1}—, amide linkages of —CONR_{N1}-, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl.

A “polydiorganosiloxane vinylic crosslinker” or “polysiloxane vinylic crosslinker” interchangeably refers to a compound comprising at least one polysiloxane segment and at least two ethylenically-unsaturated groups.

The term “fluid” as used herein indicates that a material is capable of flowing like a liquid.

As used in this application, the term “clear” in reference to a polymerizable composition means that the polymerizable composition is a transparent solution or liquid mixture having a light transmissibility of 85% or greater (preferably 90% or greater) in the range between 400 nm to 700 nm.

A free radical initiator can be either a photoinitiator or a thermal initiator. A “photoinitiator” refers to a chemical that initiates free radical crosslinking/polymerizing reaction by the use of UV and/or visible light. A “thermal initiator” refers to a chemical that initiates radical crosslinking/polymerizing reaction by the use of heat energy.

The term “acyl germanium photoinitiator” refers to an organogermanium compound that is a germanium-based Norrish Type I photoinitiator and comprises at least one acrylcarbonyl group connected to germanium. Examples of such acyl germanium photoinitiators are described in U.S. Pat. Nos. 7,605,190 and 10,324,311.

As used in this application, the term “polymer” means a material formed by polymerizing/crosslinking one or more monomers or macromers or prepolymers or combinations thereof.

A “macromer” or “prepolymer” refers to a compound or polymer that contains ethylenically unsaturated groups and has a number average molecular weight of greater than 700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatochraphy) with one or more of a refractive index detector, a low-angle laser light scattering detector, a multi-angle laser light scattering detector, a differential viscometry detector, a UV detector, and an infrared (IR) detector; MALDI-TOF MS (matrix-assisted desorption/ionization time-of-flight mass spectroscopy); ¹H NMR (Proton nuclear magnetic resonance) spectroscopy, etc.

The term “monovalent radical” refers to an organic radical that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogel atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

A “blending vinylic monomer” refers to a vinylic monomer capable of dissolving both hydrophilic and hydrophobic components of a polymerizable composition to form a solution.

“Post-curing surface treatment”, in reference to a SiHy lens bulk material or a SiHy contact lens, means a surface treatment process that is performed after the SiHy lens bulk material or the SiHy contact lens is formed by curing (i.e., thermally or actinically polymerizing) a SiHy lens formulation.

The term “silicone hydrogel lens formulation” or “SiHy lens formulation” interchangeably refers to a polymerizable composition that comprises all necessary polymerizable components for producing a SiHy contact lens or a SiHy lens bulk material as well known to a person skilled in the art.

A “UV-absorbing vinylic monomer” refers to a compound comprising an ethylenically-unsaturated group and a UV-absorbing moiety which can absorb or screen out UV radiation in the range from 200 nm to 400 nm as understood by a person skilled in the art.

A “HEVL-absorbing vinylic monomer” refers to a compound comprising an ethylenically-unsaturated group and a HEVL-absorbing moiety which can absorb or screen out HEVL (high-energy-violet-light) radiation in the range from 380 nm to 440 nm as understood by a person skilled in the art.

“UVA” refers to radiation occurring at wavelengths between 315 nm and 380 nanm; “UVB” refers to radiation occurring between 280 nm and 315 nanm; “Violet” refers to radiation occurring at wavelengths between 380 nm and 440 nanm.

“UVA transmittance” (or “UVA % T”), “UVB transmittance” or “UVB % T”, and “HEVL-transmittance” or “HEVL % T” are calculated by the following formula.

$$UVA \% T = Average \% Transmission between 315 nm and 380 nm \times 100$$

$$UVB \% T = Average \% Transmission between 280 nm and 315 nm \times 100$$

$$HEVL \% T = Average \% Transmission between 380 nm and 450 nm \times 100$$

$$HEVL \% filtration = 100 \% - HEVL \% T$$

“% T at a wavelength” refers to a percent transmission at the specified wavelength.

“% T (λ₁, λ₂)” refers to an average % transmission between a first wavelength λ₁ and the second wavelength λ₂.

$$\% Filtration ( {λ}_{1} , {λ}_{2} ) = 1 \; 00 \% - \% T ( {λ}_{1} , {λ}_{2} )$$

The intrinsic “oxygen permeability”, Dkᵢ, of a material is the rate at which oxygen will pass through a material. As used in this application, the term “oxygen permeability (Dk)” in reference to a hydrogel (silicone or non-silicone) or a contact lens means a corected oxygen permeability (Dk_{c}) which is measured at about 34-35° C. and corrected for the surface resistance to oxygen flux caused by the boundary layer effect according to the procedures described in ISO 18369-4. Oxygen permeability is conventionally expressed in units of barrers, where “barrer” is defined as [(cm³ oxygen) (cm)/(cm²)(sec)(mm Hg)]×10⁻⁹.

The “oxygen transmissibility”, Dk/t, of a lens or material is the rate at which oxygen will pass through a specific lens or material with an average thickness of t [in units of mm] over the area being measured. Oxygen transmissibility is conventionally expressed in units of barrers/mm, where “barrers/mm” is defined as [(cm³ oxygen)/(cm²)(sec)(mm Hg)]×10⁻⁹.

The term “modulus” or “elastic modulus” in reference to a contact lens or a material means the tensile modulus or Young's modulus which is a measure of the stiffness of a contact lens or a material in tension. A person skilled in the art knows well how to determine the elastic modulus of a SiHy material or a contact lens. For example, all commercial contact lenses have reported values of elastic modulus.

A “coating” in reference to a contact lens means that the contact lens has, on its surfaces, a thin layer of a material that is different from the bulk material of the contact lens and obtained by subjecting the contact lens to a surface treatment.

“Surface modification” or “surface treatment”, as used herein, means that an article has been treated in a surface treatment process, in which (1) a coating is applied to the surface of the article, (2) chemical species are adsorbed onto the surface of the article, (3) the chemical nature (e.g., electrostatic charge) of chemical groups on the surface of the article are altered, or (4) the surface properties of the article are otherwise modified. Exemplary surface treatment processes include, but are not limited to, a surface treatment by energy (e.g., a plasma, a static electrical charge, radiation, or other energy source), chemical treatments, the grafting of hydrophilic vinylic monomers or macromers onto the surface of an article, mold-transfer coating process disclosed in U.S. Pat. No. 6,719,929, the incorporation of wetting agents into a lens formulation for making contact lenses proposed in U.S. Pat. Nos. 6,367,929 and 6,822,016, reinforced mold-transfer coating disclosed in U.S. Pat. No. 7,858,000, and a hydrophilic coating composed of covalent attachment or physical deposition of one or more layers of one or more hydrophilic polymer onto the surface of a contact lens disclosed in US Pat. Nos. 8,147,897, 8,409,599, 8,557,334, 8,529,057, and 9,505,184.

A “hydrophilic surface” in reference to a SiHy material or a contact lens means that the SiHy material or the contact lens has a surface hydrophilicity characterized by having an averaged water contact angle of about 90 degrees or less, preferably about 80 degrees or less, more preferably about 70 degrees or less, more preferably about 60 degrees or less.

An “average contact angle” refers to a water contact angle (static water contact angle measured by Sessile Drop), which is obtained by averaging measurements of at least 3 individual contact lenses.

The term “central axis” in reference to a contact lens means a line passing through the geometrical centers of the anterior and posterior surfaces of the contact lens.

An “unprocessed contact lens” refers to a contact lens which is obtained by cast-molding of a polymerizable composition in a mold and has not been subjected to extraction and/or hydration post-molding processes.

The term “extraction” refers to a post-molding process in which a contact lens is immersed in a solvent to remove unreacted and/or partially reacted components in a polymerizable composition for cast-molding of the contact lens.

The term “hydration” refers to a post-molding process in which a contact lens is immersed in water or an aqueous solution.

In general, the invention is directed to reactive dyes having a dichlorotriazine group useful for making centrally colored contact lenses, in particular, centrally colored SiHy contact lenses, only a part or all of the central circular regions of which is colored to selectively filter radiations of certain wavelengths (i.e., blocking at least 60% of the radiations of the specified wavelengths). The invention is partly based on the discovery that a dye-fixing process could be implanted directly and conveniently in a contact lens production line to selectively apply a colorant to a part (e.g., an annular ring or a circular area) or all of central circular region of a contact lens having hydroxyl groups in the polymer matrix of the contact lens. Because the entiry lens body from the front surface to the back surface withing the central circular region of a contact lens is colored by a reactive dye, the concentration and reactivity of the reactive dye may not need to be so high to impart resultant contact lenses having a relatively high capability of blocking a color light having a desired range of wavelengths (e.g., blue-gree light, orange-red light).

The invention, in one aspect, provides a reactive dye of any one of formula (1), (2) and (3)

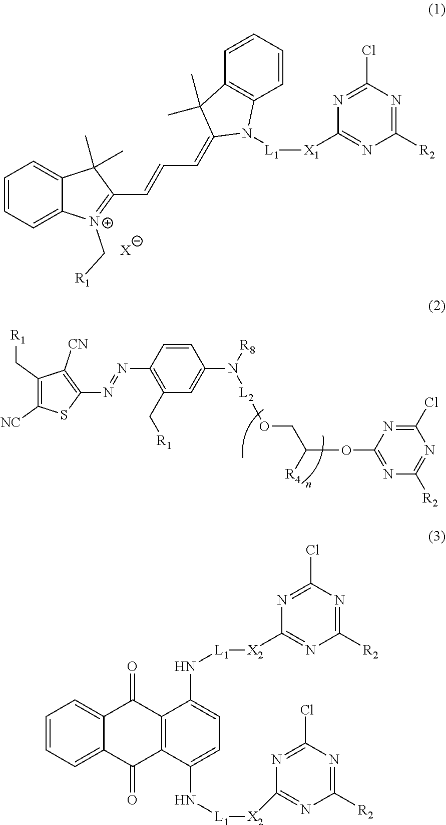

in which: X⁻ is a negatively-charged counter ion (preferably I, Br, Cl, R₃COO⁻, R₃SO₃⁻ or Bis(oxalate)borate) or a negatively charged group of R₁; R₁ is H or a C₁-C₁₀ alkyl which is optionally substituted with one or more functional groups selected from the group consisting of OH, OCH₃, OC₂H₅, COOH, COOR₅, NR₆R₇, SO₃⁻, and combinations thereof (preferably H); R₂ is H or Cl (preferably Cl); R₄ is H or CH₃; R₃ and R₅ independent of each other are a C₁-C₄ alkyl; R₆ and R₇ independent of each other are H or a C₁-C₄ alkyl; L₁ is a C₂-C₁₀ alkylene divalent radical or a divalent radical of

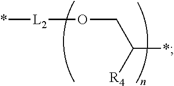

L₂ independent of each other are a C₂-C₁₀ alkylene divalent radical; R₈ is a C₁-C₁₀ alkyl which is optional substituted with one or more functional groups selected from the group consisting of OH, OCH₃, OC₂H₅, COOH, COOR₅, NR₆R₇, SO₃⁻, and combinations thereof or is a monovalent radical of

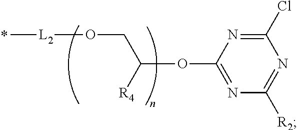

### X₁ is

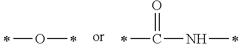

in which the nitrogen atom is connected to triazine; X₂ is

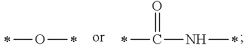

and n and m independent of each other are an integer of 1 to 10.

A reactive dye of the invention can be prepared from a dye having at least one hydroxyl group and triclorotriazine according to the known coupling reaction between a hydroxyl group and a chlorotriazine group for forming an ether linkage as known in the art.

A reactive dye of formula (1) can be prepared from commercially available starting materials, 2,3,3-trimethyl-3H-indole [1], one or two halogen compounds each having one sole bromine (R₁—Br and/or Q₁-L₁-Br in which Q₁ is OH or COOH), N,N′-diphenylformamidine

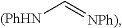

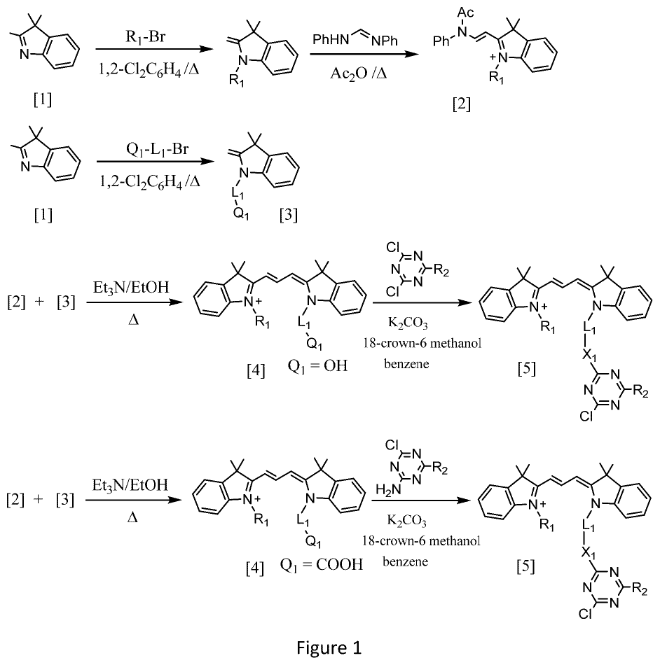

and a triazine derivative of

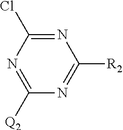

in which Q₂ is Cl or NH₂, according to the reactions known for preparing Cy3 dyes (see, Jung, M. E., Kim, W J., Avliyakulov, N. K., Oztug, M., Haykinson, M. J. (2012). Synthesis and Validation of Cyanine-Based Dyes for DIGE. In: Cramer, R., Westermeier, R. (eds) Difference Gel Electrophoresis (DIGE). Methods in Molecular Biology, vol 854. Humana Press) in combination with the coupling reaction between two co-reactive functional groups (e.g., between hydroxyl group and di- or trichlorotriazine or between NH₂ and COOH) as illustrated in FIG. 1.

Alternatively, where compound [4] is commercially available, a reactive dye of formula (1) can be directly prepared by reacting compound [4] with triclorotriazine or dichlorotrizine.

A reactive dye of formul (2) can be prepared from commercially available starting materials, 2-amino-3,5-dicyano-4-(C₂-C₁₀ unsubstituted or substituted alkyl) thiophene (e.g., 2-amino-3,5-dicyano-4-methylthiphene, 2-amino-3,5-dicyano-4-ethylthiphene, etc.) [6], N,N-dialkyl-substituted-meta-substituted aniline of

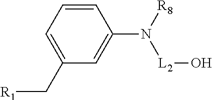

(e.g., N,N-bis(2-hydroxyethyl)-m-toluidine, N,N-bis(3-hydroxypropyl)-m-toluidine, 2-(N-ethyl-N-m-toluidino)ethanol, 2-(N-methyl-N-m-toluidino)ethanol, 3-(N-ethyl-N-m-toluidino)propanol, 3-(N-methyl-N-m-toluidino)propanol, etc.) [7], ethylene oxide (or propylene oxide) [9], and a triazine derivative of

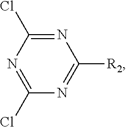

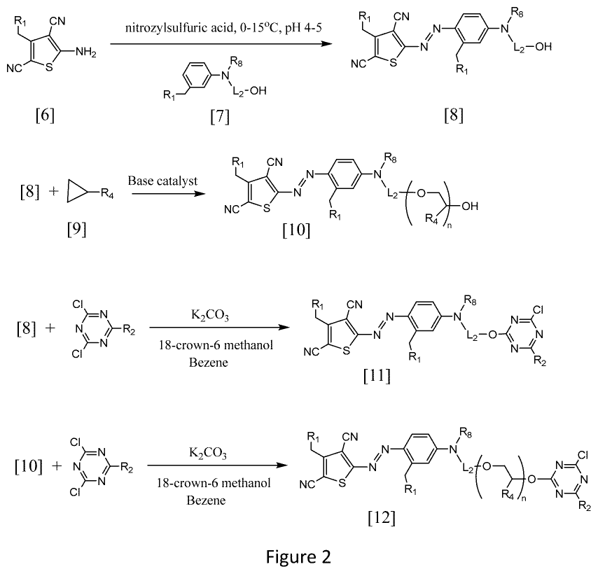

according to the reactions known for preparing thiophen-based azo dyes (see, e.g., M. M. Andou, Am. J. Chem. 2013, 3(5):126-135) and polyoxyethylene oligomers, in combination with the coupling reaction between hydroxyl group and di- or trichlorotriazine, as illustrated in FIG. 2.

Alternatively, where compound [8] is commercially available, a reactive dye of formula (2) can be directly prepared by reacting compound [8] with triclorotriazine or dichlorotrizine.

A reactive dye of formula (3) can be prepared by reacting commercially available 1,4-diaminoanthraquinone [13] with a halogen compound of Q₃-L₁-Br in which Q₃ is OH, COOH or NHBoc (Boc is t-butoxycarbonyl) [14] to form an reactive intermediate,

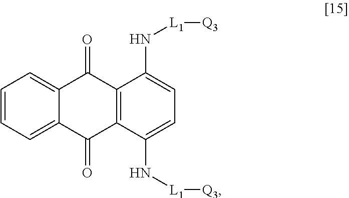

followed by reacting compound [15] with a triazine derivative of

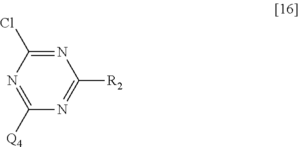

in which Q₄ is Cl, NH₂ or COOH according to coupling reaction between two co-reactive functional groups (e.g., between NH₂ and bromo, between hydroxyl group and di- or trichlorotriazine, between NH₂ and COOH).

Compound [15] can also be prepared according to the procedures described in the article by A. Wcislo, et al. (Spectrochimica Acta Part A: Molecular and Biomolecular Spectrocopy 2013, 108:82-88). For example, 1,4-bis(4-ptoluenesulphonyloxy)-9,10-anthraquinone reacts with an excess of

Compounds [13] (1,4-diaminoanthraquinone) is commercially available.

Examples of commercially available comounds [14] include without limitation 2-bromoethanol, 3-bromopropanol, 4-bromobutanol, 5-bromopentanol, 6-bromohexanol, 2-bromoacetic acid, 3-bromopropanoic acid, 4-bromobutanoic acid, 5-bromopentanoic acid, 6-bromohexanoic acid, 2-(Boc-amino)ethyl bromide, 3-(Boc-amino)propyl bromide, 4-(Boc-amino)butyl bromide, 5-(Boc-amino)pentyl bromide, 6-(Boc-amino)hexyl bromide, and the likes.

Examples of commercially available compounds [16] includes without limitation 2-amino-4,6-dichloro-1,3,5-triazine, 4,6-dichloro-1,3,5-triazine-2-carboxylic acid, 4-amino-2-chloro-1,3,5-triazine, 4-amino-2-chloro-1,3,5-triazine, 2,4-dichloro-1,3,5-triazine.

Alternatively, if compound [15] is commercially available, then a reactive dye of formula (3) can be prepared by reacting compound [15] with a compound [16].

Examples of compounds [15] include without limitation 1,4-bis(2-hydroxyethylamino)-9,10-anthraquinone, 1,4-bis(3-hydroxypropylamino)-9,10-anthraquinone, 1,4-bis[(2-aminoethyl)amino]-9,10-anthraquinone, 1,4-bis(3-hydroxypropylamino)-9,10-anthraquinone, and the likes.

A reactive dye of the invention described above can find particular uses in making centrally-colored contact lenses (preferably centrally colored silicone hydrogel contact lenses) the polymer matrix of which comprises hydroxyl groups.

In another aspect, the present invention provides a method for producing centrally colored contact lenses (preferably silicone hydrogel contact lenses). It comprises the steps of: (1) obtaining a polymerizable fluid composition comprising (a) at least one silicone-containing vinylic monomer optionally having at least one hydroxyl group and/or at least one polysiloxane vinylic crosslinker optionally having at least one hydroxyl group, (b) at least one hydrophilic vinylic monomer, (c) at least one hydroxyl-containing polymerizable material selected from the group consisting of said at least one silicone-containing vinylic monomer having at least one hydroxyl group, said at least one polysiloxane vinylic crosslinker having at least one hydroxyl group, a non-silicone hydroxyl-containing vinylic monomer, and combinations thereof, (d) optionally at least one component selected from the group consisting of a non-silicone vinylic crosslinker, a non-silicone hydrophobic vinylic monomer, a UV-absorbing vinylic monomer, a HEVL-absorbing vinylic monomer, and combinations thereof, and (e) at least one first free-radical initiator; (2) introducing the polymerizable fluid composition into a lens mold, wherein the lens mold comprises a male mold half having a first molding surface and a female mold half having a second molding surface, wherein the male and female mold halves are configured to receive each other such that a mold cavity is formed between the first and second molding surfaces and the polymerizable fluid composition is enclosed in the mold cavity when the mold is closed; (3) curing thermally or actinically the polymerizable fluid composition in the mold cavity of the lens mold to form a contact lens precursor having a crosslinked polymer network with hydroxyl groups covalently attached thereto; (4) separating the lens mold into the male and female mold halves, with the contact lens precursor adhered onto the female mold half; (5) applying a reactive solution onto an area in a central circular region on the surface of the contact lens precursor adhered on the female mold half, wherein the reactive solution comprises a reactive dye of the invention as described above and at least one organic solvent miscible with water and has a pH of about 8.0 or lower (preferably about 7.5 or lower, more preferably from about 6.0 to about 7.5), wherein the central circular region has a diameter of about 13 mm or less and is concentric with the central axis of the contact lens precursor; (6) after the reactive solution has penetrated and diffused into the crosslinked polymer network, drying the contact lens precursor adhered onto the female mold half to obtain a dried contact lens precursor with the reactive dye distributed in the central circular region; (7) removing the dried contact lens precursor from the lens-adhered mold half; (8) optionally rinsing the dried contact lens precursor obtained in step (7) with water to obtain a hydrated contact lens precursor containing the reactive dye in the central region; (9) immersing the dried contact lens precursor obtained in step (7) or the hydrated contact lens precursor obtained in step (8) in an alkaline aqueous solution (having a pH of preferably from about 9.5 to about 12.0, more preferably from about 10.0 to about 12.0, even more preferably from about 10.5 to about 11.5) at a temperature from about 50° C. to about 90° C. for a time sufficient for covalently attaching the reactive dye to the crosslinked polymer matrix to obtain a centrally-colored contact lens; and (10) subjecting the centrally colored contact lens obtained in step (9) to at least one of post-molding processes selected from the group consisting of hydration, extraction, surface treatment, packaging, sterilization (autoclaving), and combinations thereof.

Any silicone-containing vinylic monomer can be used in the invention. Examples of preferred silicone-containing vinylic monomers can be silicone-containing (meth)acrylamido monomers, silicone-containing (meth)acryloxy monomers, silicone-containing vinylcarbonato monomers, or silicone-containing vinylcarbamato monomers, each of which comprises a bis(trialkylsilyloxy)alkylsilyl group, a tris(trialkylsilyloxy)-silyl group, or a polysiloxane chain having 2 to 30 siloxane units and terminated with an alkyl, hydroxyalkyl or methoxyalkyl group. Such preferred silicone-containing vinylic monomers can be obtained from the commercial suppliers, or alternatively prepared according to known procedures, e.g., similar to those described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827, or by reacting a vinylic monomer having a reactive functional group (e.g., an acid chloride, acid anhydride, carboxyl, hydroxyl, amino, epoxy, isocyanate, aziridine, azlactone, or aldehyde group) with a silicone-containing compound a reactive group selected from the group consisting of a hydroxyalkyl, an aminoalkyl, an alkylaminoalkyl, a carboxyalkyl, an isocyanatoalkyl, an epoxyalkyl, and an aziridinylalkyl, in the presence or absence of a coupling agent under coupling reaction conditions well known to a person skilled in the art.

Examples of preferred siloxane-containing vinylic monomers each having a bis(trialkylsilyloxy)alkylsilyl group or a tris(trialkylsilyloxy)silyl group include without limitation tris(trimethylsilyloxy)-silylpropyl (meth)acrylate, [3-(meth)acryloxy-2-hydroxypropyloxy]propyl-bis(trimethylsiloxy)-methylsilane, [3-(meth)acryloxy-2-hydroxypropyloxy]propylbis(trimethyl-siloxy)butylsilane, 3-(meth)acryloxy-2-(2-hydroxyethoxy)-propyloxy)propylbis(trimethylsiloxy)-methylsilane, 3-(meth)acryloxy-2-hydroxypropyloxy)propyl-tris(trimethylsiloxy)silane, N-[tris(trimethylsiloxy)-silylpropyl]-(meth)acrylamide, N-(2-hydroxy-3-(3-(bis(trimethylsilyloxy)-methylsilyl)propyloxy)-propyl)-2-methyl(meth)acrylamide, N-(2-hydroxy-3-(3-(bis(trimethyl-silyloxy)methylsilyl)-propyloxy)propyl) (meth)acrylamide, N-(2-hydroxy-3-(3-(tris(trimethyl-silyloxy)silyl)propyloxy)-propyl)-2-methyl acrylamide, N-(2-hydroxy-3-(3-(tris(trimethylsilyloxy)-silyl)propyloxy)propyl) (meth)acrylamide, N-[tris(dimethylpropylsiloxy)-silylpropyl]-(meth)acrylamide, N-[tris(dimethylphenylsiloxy)silylpropyl] (meth)acrylamide, N-[tris(dimethyl-ethylsiloxy)silylpropyl] (meth)acrylamide, N,N-bis[2-hydroxy-3-(3-(bis(trimethyl-silyloxy)methyl-silyl) propyloxy)propyl]-2-methyl (meth)acrylamide, N,N-bis[2-hydroxy-3-(3-(bis(trimethylsilyloxy)-methylsilyl) propyloxy)-propyl] (meth)acrylamide, N,N-bis[2-hydroxy-3-(3-(tris(trimethylsilyloxy)-silyl)propyloxy)propyl]-2-methyl (meth)acrylamide, N,N-bis[2-hydroxy-3-(3-(tris(trimethylsilyloxy)-silyl)propyloxy)propyl] (meth)acrylamide, N-[2-hydroxy-3-(3-(t-butyldimethylsilyl)propyloxy)-propyl]-2-methyl (meth)acrylamide, N-[2-hydroxy-3-(3-(t-butyldimethylsilyl)propyloxy)propyl](meth)acrylamide, N,N-bis[2-hydroxy-3-(3-(t-butyldimethyl-silyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxy-carbonylthio)propyl-tris(trimethyl-siloxy)silane, 3-[tris(trimethylsiloxy)silyl]propylvinyl carbamate, 3-[tris(trimethylsiloxy)silyl] propyl allyl carbamate, 3-[tris(trimethylsiloxy)silyl]propyl vinyl carbonate, those disclosed in U.S. Pat. Nos. 9,097,840, 9,103,965 and 9,475,827, and mixtures thereof. The above preferred silicone-containing vinylic monomers can be obtained from commercial suppliers or can be prepared according to procedures described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827.

Examples of preferred silicone-containing vinylic monomers each having a polysiloxane chain having 2 to 30 siloxane units include without limitation α-(meth)acryloxypropyl terminated ω-butyl (or ω-methyl) terminated polydimethylsiloxane, α-(meth)acryloxy-2-hydroxypropyloxy-propyl terminated ω-butyl (or ω-methyl) terminated polydimethylsiloxane, α-(2-hydroxyl-methacryloxypropyloxypropyl)-ω-butyl-decamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxy-ethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy(polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy) propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or ω-methyl) terminated polydimethylsiloxane, α-[3-(meth)acrylamidoethoxy-2-hydroxypropyloxy-propyl]-terminated ω-butyl (or ω-methyl)polydimethylsiloxane, α-[3-(meth)acrylamido-propyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamido-butyloxy-2-hydroxypropyloxypropyl]-terminated ω-butyl (or ω-methyl) terminated polydimethylsiloxane, α-[3-(meth)acryloylamido-2-hydroxypropyloxypropyl] terminated ω-butyl (or ω-methyl) polydimethylsiloxane, α-[3-[N-methyl-(meth)acryloylamido]-2-hydroxypropyloxy-propyl] terminated ω-butyl (or ω-methyl) terminated polydimethylsiloxane, N-methyl-N′-(propyl-tetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamido-propyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, those disclosed in U.S. Pat. Nos. 9,097,840 and 9,103,965, and mixtures thereof. The above preferred polysiloxanes vinylic monomers can be obtained from commercial suppliers (e.g., Shin-Etsu, Gelest, etc.) or prepared according to procedures described in patents, e.g., U.S. Pat. Nos. 6,166,236, 6,867,245, 8,415,405, 8,475,529, 8,614,261, 9,217,813, and 9,315,669, or by reacting a hydroxyalkyl (meth)acrylate or (meth)acrylamide or a (meth)acryloxypolyethylene glycol with a mono-epoxypropyloxypropyl-terminated polydimethylsiloxane, by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane, or by reacting isocyanatoethyl (meth)acrylate with a mono-carbinol-terminated polydimethylsiloxane according to coupling reactions well known to a person skilled in the art.

In a preferred embodiment, said at least one silicone-containing vinylic monomer comprises at least one silicone-containing (meth)acrylamido monomer having a bis(trialkylsilyloxy)alkylsilyl group, a tris(trialkylsilyloxy)silyl group, or a polysiloxane chain having 2 to 30 siloxane units and terminated with an alkyl, hydroxyalkyl or methoxyalkyl group. Examples of such preferred silicone-containing (meth)acrylamido monomers include without limitation those described later in this application.

Any polysiloxane vinylic crosslinkers can be used in the invention. Examples of preferred polysiloxane vinylic crosslinkers include without limitation α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis (3-methacryloxy-2-hydroxypropyl)-alpha, omega-bis-3-aminopropyl-polydimethylsiloxane of various molecular weight; the reaction products of glycidyl methacrylate with amino-functional polydimethylsiloxanes; the reaction products of an azlactone-containing vinylic monomer (any one of those described above) with hydroxyl-functional polydimethylsiloxanes; polysiloxane-containing macromer selected from the group consisting of Macromer A, Macromer B, Macromer C, and Macromer D described in U.S. Pat. No. 5,760,100; polysiloxane vinylic crosslinkers disclosed in U.S. Pat. Nos. 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10,081,697, 10,301,451, and 10,465,047.

One class of preferred polysiloxane vinylic crosslinkers are di-(meth)acryloyloxy-terminated polysiloxane vinylic crosslinkers each having dimethylsiloxane units and hydrophilized siloxane units each having one methyl substituent and one monovalent C₄-C₄₀ organic radical substituent having 1 to 6 hydroxyl groups, more preferably a polysiloxane vinylic crosslinker of formula (G), are described later in this application and can be prepared according to the procedures disclosed in U.S. Pat. No. 10,081,697.

Another class of preferred polysiloxane vinylic crosslinkers are vinylic crosslinkers each of which comprises one sole polydiorganosiloxane segment and two terminal (meth)acryloyl groups, which can be obtained from commercial suppliers; prepared by reacting glycidyl (meth)acrylate (meth)acryloyl chloride with a di-amino-terminated polydimethylsiloxane or a di-hydroxyl-terminated polydimethylsiloxane; prepared by reacting isocyantoethyl (meth)acrylate with di-hydroxyl-terminated polydimethylsiloxanes prepared by reacting an amino-containing acrylic monomer with di-carboxyl-terminated polydimethylsiloxane in the presence of a coupling agent (a carbodiimide); prepared by reacting a carboxyl-containing acrylic monomer with di-amino-terminated polydimethylsiloxane in the presence of a coupling agent (a carbodiimide); or prepared by reacting a hydroxyl-containing acrylic monomer with a di-hydroxy-terminated polydisiloxane in the presence of a diisocyanate or di-epoxy coupling agent.

Other classes of preferred polysiloxane vinylic crosslinkers are chain-extended polysiloxane vinylic crosslinkers each of which has at least two polydiorganosiloxane segments linked by a linker between each pair of polydiorganosiloxane segments and two terminal ethylenically unsaturated groups, which can be prepared according to the procedures described in U.S. Pat. Nos. 5,034,461, 5,416,132, 5,449,729, 5,760,100, 7,423,074, 8,529,057, 8,835,525, 8,993,651, 9,187,601, 10,301,451, and 10,465,047.

Any hydrophilic vinylic monomers can be used in the invention. Examples of preferred hydrophilic vinylic monomers are hydrophilic (meth)acrylamido monomer (as described later in this application), hydrophilic (meth)acryloxy monomer (as described later in this application), hydrophilic N-vinyl amide monomer (as described later in this application), methylene-containing pyrrolidone monomers (i.e., pyrrolidone derivatives each having a methylene group connected to the pyrrolidone ring at 3- or 5-position) (as described later in this application), vinyl ether monomers (as described later in this application), allyl ether monomers (as described later in this application), phosphorylcholine-containing vinylic monomers (as described later in this application), allyl alcohol, N-2-hydroxyethyl vinyl carbamate, N-vinyloxycarbonyl-β-alanine (VINAL), N-vinyloxycarbonyl-α-alanine, and combinations thereof.

Examples of preferred hydrophilic (meth)acrylamido monomers include without limitation (meth)acrylamide, N-methyl (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, N-2-hydroxylethyl (meth)acrylamide, N-3-hydroxypropyl (meth)acrylamide, N-2-hydroxypropyl (meth)acrylamide, N-2,3-dihydroxypropyl (meth)acrylamide, N-4-hydroxybutyl (meth)acrylamide, N,N-bis(2-hydroxyethyl) (meth)acrylamide, N-tris(hydroxymethyl) methyl (meth)acrylamide, 2-(meth)acrylamidoglycolic acid, 3-(meth)acrylamidopropionic acid, 4-(meth)acrylamido-butanoic acid, 3-(meth)acrylamido-2-methylbutanoic acid, 3-(meth)acrylamido-3-methylbutanoic acid, 2-(meth)acrylamido-2-methyl-3,3-dimethyl butanoic acid, 5-(meth)acrylamidopentanoic acid, 3-(meth)acrylamidohaxanoic acid, 4-(meth)acrylamido-3,3-dimethylhexanoic acid, (3-(meth)acrylamidophenyl)boronic acid, 3-((3-methacrylamidopropyl)dimethylammonio)-propane-1-sulfonate; 3-((3-acrylamidopropyl)dimethylammonio)propane-1-sulfonate, N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, poly(ethylene glycol)ethyl (meth)acrylamide having a number average molecular weight of up to 700, methoxy-poly(ethylene glycol)ethyl (meth)acrylamide having a number average molecular weight of up to 700, and combinations thereof. The most preferred hydrophilic (meth)acrylamido monomers are (meth)acrylamide, N-methyl (meth)acrylamide, N,N-dimethyl (meth)acrylamide, N-ethyl (meth)acrylamide, N-2-hydroxylethyl (meth)acrylamide, and combinations thereof.

Examples of preferred hydrophilic (meth)acryloxy monomers include without limitation 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, (meth)acrylic acid, ethylacrylic acid, propylacrylic acid, butylacrylic acid, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, and combinations thereof. The most preferred hydrophilic (meth)acryloxy monomers are 2-hydroxyethyl (meth)acrylate, 3-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, and combinations thereof.

Examples of preferred hydrophilic N-vinyl amide monomers include without limitation N-vinylpyrrolidone, N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (aka, N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (aka, N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof. The most preferred hydrophilic N-vinyl amide monomers are limitation N-vinylpyrrolidone, N-vinyl-N-methyl acetamide, and combinations thereof.

Examples of preferred methylene-containing pyrrolidone monomers include without limitation 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and combinations thereof.

Examples of preferred hydrophilic vinyl ether monomers include without limitation ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof.

Examples of preferred hydrophilic allyl ether monomers include without limitation ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof.

Examples of preferred phosphorylcholine-containing vinylic monomers include without limitation (meth)acryloyloxyethyl phosphorylcholine, (meth)acryloyloxypropyl phosphorylcholine, 4-((meth)acryloyloxy) butyl-2′-(trimethylammonio)ethylphosphate, 2-[(meth)acryloylamino]-ethyl-2′-(trimethylammonio)-ethylphosphate, 3-[(meth)acryloylamino]propyl-2′-(trimethylammonio)-ethylphosphate, 4-[(meth)acryloylamino]butyl-2′-(trimethylammonio)-ethylphosphate, 5-((meth)acryloyloxy) pentyl-2′-(trimethylammonio)ethyl phosphate, 6-((meth)acryloyloxy)hexyl-2′-(trimethylammonio)-ethylphosphate, 2-((meth)acryloyloxy)-ethyl-2′-(triethylammonio)-ethylphosphate, 2-((meth)acryloyloxy)ethyl-2′-(tripropylammonio)ethylphosphate, 2-((meth)acryloyloxy)ethyl-2′-(tributylammonio)ethyl phosphate, 2-((meth)acryloyloxy)propyl-2′-(trimethylammonio)-ethylphosphate, 2-((meth)acryloyloxy)butyl-2′-(trimethylammonio)-ethylphosphate, 2-((meth)acryloyloxy)-pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)-ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)-ethylphosphate, 2-(vinylcarbonylamino)ethyl-2′-(trimethylammonio)-ethylphosphate, 2-(allyloxycarbonylamino)ethyl-2′-(trimethylammonio)ethyl phosphate, 2-(butenoyloxy)ethyl-2′-(trimethylammonio) ethylphosphate, and combinations thereof.

In a preferred embodiment, said at least one hydrophilic vinylic monomer comprises at least one hydrophilic (meth)acrylamido monomer, preferably having 3 to 10 carbon atoms. Examples of most preferred hydrophilic (meth)acrylamido monomers are N,N-dimethyl (meth)acrylamide, N-ethyl (meth)acrylamide, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, (meth)acrylamide, N-(2-aminoethyl) (meth)acrylamide, N-(3-aminopropyl) (meth)acrylamide, or combinations thereof.

In another preferred embodiment, said at least one hydrophilic vinylic monomer comprises at least one hydrophilic N-vinyl amide monomer. Examples of most preferred hydrophilic N-vinyl amide monomers are N-vinylpyrrolidone and/or N-vinyl-N-methyl acetamide.

In another preferred embodiment, said at least one hydrophilic vinylic monomer comprises at least one hydrophilic (meth)acryloxy monomer, preferably having 3 to 10 carbon atoms. Examples of preferred hydrophilic (meth)acryloxy monomers are described above in this application. It is understood that any hydrophilic (meth)acryloxy monomers other than those specifically described later in this application can also be used in this invention.

In a preferred embodiment, the polymerizable composition comprises a non-silicone hydroxyl-containing vinylic monomer which can be a hydrophilic vinylic monomer or a hydrophobic vinylic monomer.

Examples of hydroxyl-containing non-silicone vinylic monomers include without limitation C₂-C₆ hydroxyalkyl (meth)acrylates, C₂-C₆ hydroxyalkyl (meth)acrylamides, N-2-hydroxyethyl vinyl carbamate, and combinations thereof. Examples of preferred hydroxyl-containing non-silicone vinylic monomers include without limitation, 2-hydroxyethyl (meth)acrylate, 3-hydroxypropyl (meth)acrylate, 2-hydroxypropyl (meth)acrylate, glycerol methacrylate (GMA), hydroxybutyl (meth)acrylate, dimethylhydroxyethyl (meth)acrylate, di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, 3-amino-2-hydroxypropyl (meth)acrylate, trimethylammonium 2-hydroxy propyl (meth)acrylate hydrochloride, N-2-hydroxylethyl (meth)acrylamide, N-3-hydroxypropyl (meth)acrylamide, N-2-hydroxypropyl (meth)acrylamide, N-2,3-dihydroxypropyl (meth)acrylamide, N-4-hydroxybutyl (meth)acrylamide, N,N-bis(2-hydroxyethyl) (meth)acrylamide, N-tris(hydroxymethyl) methyl (meth)acrylamide, N-2-hydroxyethyl vinyl carbamate, or combinations thereof.

It is understood that, when a polymerizable composition of the invention comprises a silicone-containing vinylic monomer having at least one hydroxyl group, this hydroxyl-containing silicone-containing vinylic monomer can be used not only as one of the polymerizable materials of component (a) but also as one of the polymerizable materials of component (c).

It is also understood that, when a polymerizable composition of the invention comprises a polysiloxane vinylic crosslinker having at least one hydroxyl group, this hydroxyl-containing polysiloxane vinylic crosslinker can be used not only as one of the polymerizable materials of component (a) but also as one of the polymerizable materials of component (c).

It is further understood that, when a polymerizable composition of the invention comprises a hdyrophilic vinylic monomer having at least one hydroxyl group, this hydroxyl-containing hydrophilic vinylic monomer can be used not only as one of the polymerizable materials of component (b) but also as one of the polymerizable materials of component (c).

Any non-silicone vinylic crosslinkers can be used in the invention. Examples of preferred non-silicone vinylic crosslinkers are described later in this application.

Examples of preferred non-silicone vinylic crosslinkers include without limitation ethyleneglycol di-(meth)acrylate, diethyleneglycol di-(meth)acrylate, triethyleneglycol di-(meth)acrylate, tetraethyleneglycol di-(meth)acrylate, glycerol di-(meth)acrylate, 1,3-propanediol di-(meth)acrylate, 1,3-butanediol di-(meth)acrylate, 1,4-butanediol di-(meth)acrylate, glycerol 1,3-diglycerolate di-(meth)acrylate, ethylenebis[oxy(2-hydroxypropane-1,3-diyl)] di-(meth)acrylate, bis[2-(meth)acryloxyethyl] phosphate, trimethylolpropane di-(meth)acrylate, and 3,4-bis[(meth)acryloyl]tetrahydrofuan, diacrylamide (i.e., N-(1-oxo-2-propenyl)-2-propenamide), dimethacrylamide (i.e., N-(1-oxo-2-methyl-2-propenyl)-2-methyl-2-propenamide), N,N-di(meth)acryloyl-N-methylamine, N,N-di(meth)acryloyl-N-ethylamine, N,N′-methylene bis(meth)acrylamide, N,N′-ethylene bis(meth)acrylamide, N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamide-propane-2-yl dihydrogen phosphate (i.e., N,N′-2-phophonyloxypropylene bis(meth)acrylamide), piperazine diacrylamide (or 1,4-bis(meth)acryloyl piperazine), tetraethyleneglycol divinyl ether, triethyleneglycol divinyl ether, diethyleneglycol divinyl ether, ethyleneglycol divinyl ether, triallyl isocyanurate, triallyl cyanurate, trimethylopropane trimethacrylate, pentaerythritol tetramethacrylate, bisphenol A dimethacrylate, and combinations thereof.

Any non-silicone hydrophobic vinylic monomers can be used in the invention. Examples of preferred hydrophobic non-silicone vinylic monomers can be non-silicone hydrophobic acrylic monomers (e.g., alkyl (meth)acrylates as described below, cycloalkyl (meth)acrylates as described below, phenyl methacrylate, (meth)acrylonitrile, etc.), fluorine-containing acrylic monomers (e.g., perfluorohexylethyl-thio-carbonyl-aminoethyl-methacrylate, perfluoro-substituted-C₂-C₁₂ alkyl (meth)acrylates described below, etc.), vinyl alkanoates (e.g., vinyl acetate, vinyl propionate, vinyl butyrate, vinyl valerate, etc.), vinyloxyalkanes (e.g., vinyl ethyl ether, propyl vinyl ether, n-butyl vinyl ether, isoputyl vinyl ether, cyclohexyl vinyl ether, t-butyl vinyl ether, etc.), substituted or unsubstituted styrenes as described below, vinyl toluene, vinyl chloride, vinylidene chloride, 1-butene, and combinations thereof.

Any suitable perfluoro-substituted-C₂-C₁₂ alkyl (meth)acrylates can be used in the invention. Examples of perfluoro-substituted-C₂-C₁₂ alkyl (meth)acrylates include without limitation 2,2,2-trifluoroethyl (meth)acrylate, tetrafluoropropyl (meth)acrylate, hexafluoro-iso-propyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, and combinations thereof.

In a preferred embodiment, one or more hydrophobic non-silicone acrylic monomers and/or substituted or unsubstituted styrenes can be used in the invention as a reactive diluent (i.e., blending vinylic monomer) for solubilizing other polymerizable components in a polymerizable composition of the invention. Examples of such non-silicone hydrophobic acrylic monomers and substituted or unsubstituted styrenes include methyl methacrylate, ethyl methacrylate, isopropyl methacrylate, sec-butyl methacrylate, tert-butyl methacrylate, cyclohexyl methacrylate, isobornyl acrylate, isobornyl methacrylate, phenyl methacrylate, 4-tert-butylstyrene, 2-methylstyrene, styrene, 4-ethoxystyrene, 2,4-dimethystyrene, 2,5-dimethylstyrene, 3,5-dimethylstyrene, and combinations thereof. More preferably, methyl methacrylate, tert-butyl methacrylate, cyclohexyl methacrylate, isobornyl acrylate, isobornyl methacrylate, or a combination thereof is used in the invention. Even more preferably, methyl methacrylate, tert-butyl methacrylate, cyclohexyl methacrylate, or a combination thereof is used in the invention.

The term “UV/HEVL-absorbing vinylic monomer” refers to a vinylic monomer that can absorb UV light and high-energy-violet-light (i.e., light having wavelength between 380 nm and 440 nm). Examples of UV-absorbing vinylic monomers and UV/HEVL-absorbing vinylic monomers are known to a person skilled in the art and are disclosed in the patents and patent application publications, e.g., U.S. Pat. No. 9,315,669, US 2018-0081197 A1, etc.

Any suitable UV-absorbing vinylic monomers and UV/HEVL-absorbing vinylic monomers can be used in the invention. Examples of preferred UV-absorbing and UV/HEVL-absorbing vinylic monomers include without limitation: 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl) benzotriazole, 2-(2′-hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxy-propyl-3′-t-butyl-phenyl)-5-chlorobenzotriazole, 2-(2′-hydroxy-5′-methacryloxypropylphenyl) benzotriazole, 2-hydroxy-5-methoxy-3-(5-(trifluoromethyl)-2H-benzo[d][1,2,3]triazol-2-yl)benzyl methacrylate (WL-1), 2-hydroxy-5-methoxy-3-(5-methoxy-2H-benzo[d][1,2,3]triazol-2-yl)benzyl methacrylate (WL-5), 3-(5-fluoro-2H-benzo[d][1,2,3]triazol-2-yl)-2-hydroxy-5-methoxybenzyl methacrylate (WL-2), 3-(2H-benzo[d][1,2,3]triazol-2-yl)-2-hydroxy-5-methoxybenzyl methacrylate (WL-3), 3-(5-chloro-2H-benzo[d][1,2,3] triazol-2-yl)-2-hydroxy-5-methoxybenzyl methacrylate (WL-4), 2-hydroxy-5-methoxy-3-(5-methyl-2H-benzo[d] [1,2,3] triazol-2-yl)benzyl methacrylate (WL-6), 2-hydroxy-5-methyl-3-(5-(trifluoromethyl)-2H-benzo[d][1,2,3]triazol-2-yl)benzyl methacrylate (WL-7), 4-allyl-2-(5-chloro-2H-benzo[d][1,2,3]triazol-2-yl)-6-methoxyphenol (WL-8), 2-{2′-Hydroxy-3′-tert-5′[3″-(4″-vinylbenzyloxy)propoxy]phenyl}-5-methoxy-2H-benzotriazole, phenol, 2-(5-chloro-2H-benzotriazol-2-yl)-6-(1,1-dimethylethyl)-4-ethenyl-(UVAM), 2-[2′-hydroxy-5′-(2-methacryloxyethyl)phenyl)]-2H-benzotriazole (2-Propenoic acid, 2-methyl-, 2-[3-(2H-benzotriazol-2-yl)-4-hydroxyphenyl]ethyl ester, Norbloc), 2-{2′-Hydroxy-3′-tert-butyl-5′-[3′-methacryloyloxypropoxy]phenyl}-2H-benzotriazole, 2-{2′-Hydroxy-3′-tert-butyl-5′-[3′-methacryloyloxypropoxy]phenyl}-5-methoxy-2H-benzotriazole (UV13), 2-{2′-Hydroxy-3′-tert-butyl-5′-[3′-methacryloyloxypropoxy]phenyl}-5-chloro-2H-benzotriazole (UV28), 2-[2′-Hydroxy-3′-tert-butyl-5′-(3′-acryloyloxypropoxy)phenyl]-5-trifluoromethyl-2H-benzotriazole (UV23), 2-(2′-hydroxy-5-methacrylamidophenyl)-5-methoxybenzotriazole (UV6), 2-(3-allyl-2-hydroxy-5-methylphenyl)-2H-benzotriazole (UV9), 2-(2-Hydroxy-3-methallyl-5-methylphenyl)-2H-benzotriazole (UV12), 2-3′-t-butyl-2′-hydroxy-5′-(3″-dimethylvinylsilylpropoxy)-2′-hydroxy-phenyl)-5-methoxybenzotriazole (UV15), 2-(2′-hydroxy-5′-methacryloylpropyl-3′-tert-butyl-phenyl)-5-methoxy-2H-benzotriazole (UV16), 2-(2′-hydroxy-5′-acryloylpropyl-3′-tert-butyl-phenyl)-5-methoxy-2H-benzotriazole (UV16A), 2-Methylacrylic acid 3-[3-tert-butyl-5-(5-chlorobenzotriazol-2-yl)-4-hydroxyphenyl]-propyl ester (16-100, CAS #96478-15-8), 2-(3-(tert-butyl)-4-hydroxy-5-(5-methoxy-2H-benzo[d][1,2,3] triazol-2-yl) phenoxy)ethyl methacrylate (16-102); Phenol, 2-(5-chloro-2H-benzotriazol-2-yl)-6-methoxy-4-(2-propen-1-yl) (CAS #1260141-20-5); 2-[2-Hydroxy-5-[3-(methacryloyloxy)propyl]-3-tert-butylphenyl]-5-chloro-2H-benzotriazole; Phenol, 2-(5-ethenyl-2H-benzotriazol-2-yl)-4-methyl-, homopolymer (9CI) (CAS #83063-87-0). In accordance with the invention, the first polymerizable fluid composition comprises about 0.1% to about 3.0%, preferably about 0.2% to about 2.5%, more preferably about 0.3% to about 2.0%, by weight of one or more UV-absorbing vinylic monomers, related to the amount of all polymerizable components in the polymerizable composition.

In accordance with the invention, a free radical initiator can be one or more photoinitiators or thermal initiators (i.e., thermal polymerization initiators).

Suitable photoinitiators are benzoin methyl ether, diethoxyacetophenone, a benzoylphosphine oxide, 1-hydroxycyclohexyl phenyl ketone and Darocur and Irgacur types, preferably Darocur 1173® and Darocur 2959®, acylgermanium photoinitiators.

Examples of benzoylphosphine initiators include 2,4,6-trimethylbenzoyldiphenyl-phosphine oxide; bis-(2,6-dichlorobenzoyl)-4-N-propylphenylphosphine oxide; and bis-(2,6-dichlorobenzoyl)-4-N-butylphenylphosphine oxide.

Any acylgermanium photoinitiators can be used in this invention, so long as they are capable of initiating a free-radical polymerization under irradiation with a light source including a light in the region of about 420 to about 500 nm. Examples of acylgermanium photoinitiators are acylgermanium compounds described in U.S. Pat. No. 7,605,190. Preferably, said at lleast one first and/or second free-radical initiator comprises at least one of the following acylgermanium compounds.

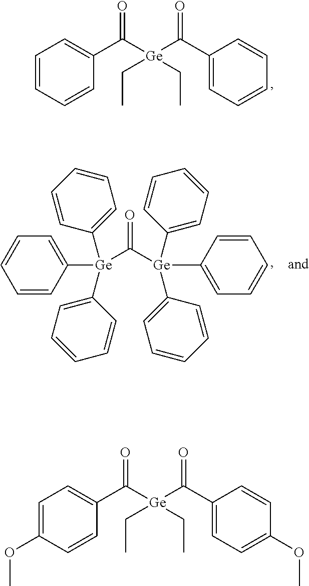

Any thermal polymerization initiators can be used in the invention. Suitable thermal polymerization initiators are known to the skilled artisan and comprise, for example peroxides, hydroperoxides, azo-bis(alkyl-or cycloalkylnitriles), persulfates, percarbonates, or mixtures thereof. Examples of preferred thermal polymerization initiators include without limitation benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydro-peroxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof. Preferably, the thermal initiator is 2,2′-azobis(isobutyronitrile) (AIBN or VAZO 64).

A polymerizable fluid composition of the invention can also comprise other necessary components known to a person skilled in the art, such as, for example, visibility tinting agent (e.g., one or more polymerizable dyes, pigments, or mixtures thereof), antimicrobial agents (e.g., silver nanoparticles), a bioactive agent (e.g., a drug, an amino acid, a polypeptide, a protein, a nucleic acid, 2-pyrrolidone-5-carboxylic acid (PCA), an alpha hydroxyl acid, linoleic and gamma linoleic acids, vitamins, or any combination thereof), leachable lubricants (e.g., a non-crosslinkable hydrophilic polymer having an average molecular weight from 5,000 to 500,000, preferably from 10,000 to 300,000, more preferably from 20,000 to 100,000 Daltons), leachable tear-stabilizing agents (e.g., a phospholipid, a monoglyceride, a diglyceride, a triglyceride, a glycolipid, a glyceroglycolipid, a sphingolipid, a sphingo-glycolipid, a fatty acid having 8 to 36 carbon atoms, a fatty alcohol having 8 to 36 carbon atoms, or a mixture thereof), mold releasing agent, and mixtures thereof, as known to a person skilled in the art.

In accordance with the invention, a polymerizable fluid composition of the invention can be a solution, a solventless blend (i.e., a fluid composition free of any non-reactive diluent-organic solvent). It can be prepared according to any techniques known to a skilled person.

For example, a polymerizable fluid composition of the invention can be any known silicone hydrogel lens formulations, so long as it contains a hydroxyl-containing polymerizable material.

Where a polymerizable fluid composition of the invention is a solution. It can be prepared by dissolving all of the desirable components in any suitable solvent known to a person skilled in the art. Example of suitable solvents includes without limitation, water, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl, alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof. Preferably, a polymerizable composition is a solution of all the desirable components in water, 1,2-propylene glycol, a polyethyleneglycol having a molecular weight of about 400 Daltons or less, or a mixture thereof.

Where a polymerizable fluid composition of the invention is a solventless blend, it can be prepared by mixing all polymerizable components and other necessary component. A solventless polymerizable composition typically comprises at least one blending vinylic monomer as a reactive solvent for dissolving all other polymerizable components of the solventless polymerizable composition. Examples of preferred blending vinylic monomers are described above and later in this application. Preferably, methyl methacrylate is used as a blending vinylic monomer in preparing a solventless polymerizable composition.

Lens molds for making contact lenses including SiHy contact lenses are well known to a person skilled in the art and, for example, are employed in cast molding or spin casting. For example, a mold (for cast molding) generally comprises at least two mold sections (or portions) or mold halves, i.e. first and second mold halves. The first mold half defines a first molding (or optical) surface and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with the polymerizable composition.

Methods of manufacturing mold sections for cast molding a contact lens are generally well known to those of ordinary skill in the art. The process of the present invention is not limited to any particular method of forming a mold. In fact, any method of forming a mold can be used in the present invention. However, for illustrative purposes, the following discussion has been provided as one embodiment of forming a mold.

In general, a mold comprises at least two mold halves (or mold sections), one male half and one female mold half. The male mold half has a first molding (or optical) surface which is in direct contact with a polymerizable composition for cast molding of a contact lens and defines the posterior (concave) surface of a molded contact lens; and the female mold half has a second molding (or optical) surface which is in direct contact with the polymerizable composition and defines the anterior (convex) surface of the molded contact lens. The male and female mold halves are configured to receive each other such that a lens-forming cavity is formed between the first molding surface and the second molding surface.

The mold halves can be formed through various techniques, such as injection molding. Methods of manufacturing mold halves for cast-molding a contact lens are generally well known to those of ordinary skill in the art. The process of the present invention is not limited to any particular method of forming a mold. In fact, any method of forming a mold can be used in the present invention. The first and second mold halves can be formed through various techniques, such as injection molding or lathing. Examples of suitable processes for forming the mold halves are disclosed in U.S. Pat. Nos. 4,444,711; 4,460,534; 5,843,346; and 5,894,002.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used. Other materials that allow UV light transmission could be used, such as quartz glass and sapphire.

In accordance with the invention, the polymerizable fluid composition can be introduced (dispensed) into a cavity formed by a mold according to any known techniques. A specific amount of a polymerizable fluid composition is typically dispensed into a female mold half by means of a dispensing device and then a male mold half is put on and the mold is closed. As the mold closes, any excess polymerizable fluid composition is pressed into an overflow provided on the female mold half (or alternatively on the male mold half).

The closed mold containing the polymerizable fluid composition subsequently is cured (i.e., polymerized) thermally or actinically.

In a preferred embodiment, the curing step is carried out actinically, i.e., irradiating the closed mold containing the polymerizable fluid composition with a UV or visible light, as known to a person skilled in the art, to produce a molded unprocessed contact lens (i.e., a contact lens precursor).

Where the polymerizable composition comprises a UV-absorbing vinylic monomer and a HEVL-absorbing vinylic monomer, the free radical initiator is a visible light photoinitiator (e.g., a benzoylphosphine initiator and/or an acylgermanium photoinitiator) and crosslinking is initiated upon exposure to a visible light in a region between 420 nm to 500 nm to crosslink the polymerizable components in the first polymerizable fluid composition to form molded unprocess contact lenses. Light source can be any ones emitting light in the 420-500 nm range sufficient to activate acylgermanium photoinitiators. Blue-light sources are commercially available and include: the Palatray CU blue-light unit (available from Heraeus Kulzer, Inc., Irvine, Calif.), the Fusion F450 blue light system (available from TEAMCO, Richardson, Tex.), Dymax Blue Wave 200, LED light sources from Opsytec (435 nm, 445 nm, 460 nm), and the GE 24″ blue fluorescent lamp (available from General Electric Company, U.S.). A preferred blue-light source is the LED from Opsytec (those described above).

In a preferred embodiment, the curing step is carried out thermally in an oven to produce a contact lens precursor. The reaction time may vary within wide limits, but is conveniently, for example, from 1 to 24 hours or preferably from 2 to 12 hours. It is advantageous to previously degas the components and solvents used in the polymerization reaction and to carry out said copolymerization reaction under an inert atmosphere, e.g., under N₂ or Ar atmosphere. Preferably, the oven with the molds therein is purged with nitrogen by flowing nitrogen gas through the oven. It is understood that the thermal curing step can be carried out at one or more curing temperatures as known to person skilled in the art and illustrated in Examples.

Where the curing step is carried out thermally, it is carried out in an oven at one or more curing temperatures of from about 45° C. to about 100° C. under a nitrogen environment for at least 45 minutes (preferably at least 60 minutes, more preferably at least 90 minutes, even more preferably at least 120 minutes) to form a contact lens precursor, wherein the nitrogen environment in the oven is maintained by flowing nitrogen gas through the oven at a first flow rate. The method of the invention further comprises a post-curing treatment process that include the steps of: raising oven temperature to a post-curing temperature of about 105° C. or higher (preferably at least about 110° C., more preferably at least about 115° C., even more preferably at least about 120° C.) while increasing the flow rate of nitrogen gas through the oven to a second flow rate which is at least about 1.5 folds (preferably at least about 2.0 folds, more preferably at least about 3.0 folds, even more preferably at least about 4.0 folds) of the first flow rate; heating the lens mold with the contact lens precursor therewithin in the oven at the post-curing temperature under nitrogen gas flow through the oven at the second flow rate for at least about 30 minutes (preferably at least about 60 minutes, more preferably at least about 90 minutes, even more preferably at least about 120 minutes).

After curing and optionally the post-curing treatment, the molds can be opened and separated according to any techniques known to a person skilled in the art. After the mold is separated, the contact lens precursor adheres to one of the male and female mold halves.

The step of separating the mold can be carried out according to any techniques known to a person skilled in the art. It is understood that the molded contact lens (unproceesed contact lens) is adhered onto the second molding surface of the female mold. Many techniques are known in the art. For example, the second molding surface of the female mold half designed to adhere the molded contact lens (contact lens precursor) can be surface-treated to render the molded contact lens preferentially adhered to the second molding surface of the female mold half. Alternatively, a compression force can be applied by using a mold-opening device to non-optical surface (opposite to the first molding surface) of the male mold half (not adhering the molded contact lens) of the mold at a location about the center area of non-optical molding surface at an angle of less than about 30 degrees, preferably less than about 10 degrees, most preferably less than about 5 degrees (i.e., in a direction substantially normal to center area of non-optical molding surface) relative to the axis of the mold to deform the mold half, thereby breaking bonds between the first molding surface of the male mold half and the molded contact lens. Various ways of applying a force to non-optical surface of the male mold half at a location about the center area of non-optical molding surface along the axis of the mold to deform the male mold half which breaks the bonds between the optical molding surface of the male mold half and the molded contact lens. It is understood that the mold-opening device can have any configurations known to a person skilled in the art for performing the function of separating two mold halves from each other.

Any organic solvent can be used in preparing a reactive solution of the invention so long as it is miscible with water. The examples of preferred organic solvents are described above in this application and can be used in this embodiment of the invention. Preferably, the organic solvents are a C₁-C₃ alkyl alcohol, or combinations thereof. It is believed that when an organic solvent is used, alone or in combination with water, in forming a reactive solution, the reactive dye solution can more easily penetrate into the contact lens to enable the reactive dye trapped in the bulk material of the contact lens.

A specific amount of a reactive solution is dispensed in a central region on the surface of the contact lens precursor adhered on the female mold half according to any techniques known to a person skilled in the art. Because the second molding surface of the female mold half is concave, the dispensed reactive solution can be centered in the central pupillar region of the contact lens precursor.

After the reactive solution has penetrated and diffused into the crosslinked polymer network, the resultant contact lens precursor is dried according to any known techniques, e.g., in a fume hood overnight or in a vacuum oven at a temperature of from about 55° C. to about 90° C. for approximately 30 to 120 minutes (e.g., 75° C. for 90 minutes).

The dried contact lens precursor can be removed from the female mold half according to any known techniques and then directly be immersed in an alkaline aqueous solution at an elevated temperature (i.e., a temperature of from about 50° C. to about 90° C., preferably from about 55° C. to about 85° C., more preferably from about 60° C. to about 80° C., even more preferably from about 65° C. to about 80° C.). Alternatively, the dried contact lens precursor can be first rinsed with water to obtain a hydrated contact lens precursor containing the reactive dye distributed in the central circular region and then be immersed in an alkaline aqueous solution at an elevated temperature (i.e., a temperature of from about 50° C. to about 90° C., preferably from about 55° C. to about 85° C., more preferably from about 60° C. to about 80° C., even more preferably from about 65° C. to about 80° C.).

In accordance with the invention, the time for immersing the dried contact lens precursor or the hydrated contact lens precursor is sufficient long so as to covalently attaching the reactive dye to the crosslinked polymer network of the contact lens. It is understood that the time depends upon the temperature of the alkaline aqueous solution. The higher the temperature, the shorter the time. The immersing time is from about 15 minutes to about 90 minutes, preferably from about 20 minutes to about 75 minutes, more preferably from about 25 minutes to about 60 minutes, even more preferably from about 25 minutes to about 45 minues.

The resultant centrally colored contact lenses can also subject to further processes, such as, for example, hydration, extraction, surface treatment (for example, such as, plasma treatment, chemical treatments, the grafting of hydrophilic monomers or macromers onto the surface of a lens, Layer-by-layer coating, in-package crosslinking of a thermally-reactive hydrophilic polymeric material, etc.); packaging in lens packages with a packaging solution which can contain about 0.005% to about 5% by weight of a wetting agent (e.g., a hydrophilic polymer), a viscosity-enhancing agent (e.g., methyl cellulose (MC), ethyl cellulose, hydroxymethylcellulose, hydroxyethyl cellulose (HEC), hydroxypropylcellulose (HPC), hydroxypropylmethyl cellulose (HPMC), or a mixture thereof), or an in-package-coating material; sterilization such as autoclave at from 118 to 124° C. for at least about 30 minutes; and the like.

Preferred surfaces treatments are LbL coating such as those described in U.S. Pat. Nos. 6,451,871, 6,719,929, 6,793,973, 6,811,805, and 6,896,926, plasma treatment, in-package-coating such as those disclosed in U.S. Pat. Nos. 8,557,334, 8,529,057 and 9,505,184. A preferred plasma treatment is those processes in which an ionized gas is applied onto the surface of an article as described in U.S. Pat. Nos. 4,312,575 and 4,632,844.

The centrally colored silicone hydrogel contact lens is hydrated in water or an aqueous solution to replace the liquid extraction medium, according to any method known to a person skilled in the art.

The centrally colored silicone hydrogel contact lens can be extracted with an organic solvent to remove unreacted or partially reacted polymerizable materials as known to a person skilled in the art.

The hydrated, extracted, and/or surface-treated centrally colored contact lens can further subject to further processes, such as, for example, packaging in lens packages with a packaging solution which is well known to a person skilled in the art; sterilization such as autoclave at from 118 to 124° C. for at least about 30 minutes; and the like.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

A centrally colored SiHy contact lens of the invention has an oxygen permeability of preferably at least about 40 barrers, more preferably at least about 60 barrers, even more preferably at least about 80 barrers (at about 35° C.).

A centrally colored silicone hydrogel contact lens of the invention has an elastic modulus of about 1.5 MPa or less, preferably about 1.2 MPa or less, more preferably from about 0.3 MPa to about 1.0 MPa (at a temperature of from about 22° C. to 28° C.).

A centrally colored silicone hydrogel contact lens of the invention further has an equilibrium water content of from about 15% to about 75%, more preferably from about 20% to about 70% by weight, even more preferably from about 25% to about 65% by weight (at room temperature) when fully hydrated. The equilibrium water content of a centrally colored silicone hydrogel contact lens can be measured according to the procedure disclosed in Example 1.

In a further aspect, the invention provides a colored silicone hydrogel contact lens, comprising (1) a polymer matrix having hydroxyl groups covalently attached thereonto; and (2) a colored annular ring and/or a colored central circular area both of which are located in a central circular region of the colored silicone hydrogel contact lens, wherein the central circular region has a diameter of about 9.0 mm or less (preferably about 8.5 mm or less, more preferably about 8.0 mm or less, even more preferably about 7.5 mm or less) wherein the colored annular ring and the colored central circular area independent of each other comprise at least one reactive dye of the invention as described above which is covalently attached onto the polymeri matrix through linkages formed between one hydroxyl group and a dichlorotriazine or chlorotriazine of the reactive dye, wherein the colored annular ring and the colored circular area are concentric with the central axis of the colored silicone hydrogel contact lens.

All of the various embodiments of the molds, polymerizable composition, and spatial limitation of radiation, and contact lens of the invention described above can be used in this aspect of the invention.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part or can be combined in any manner and/or used together, as illustrated below:

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

### Example 1

### Oxygen Permeability Measurements

Unless specified, the oxygen transmissibility (Dk/t), the intrinsic (or edge-corrected) oxygen permeability (Dkᵢ or Dk_{c}) of a lens and a lens material are determined according to procedures described in ISO 18369-4.

### Surface Wettability Tests

Water contact angle (WCA) on a contact lens is a general measure of the surface wettability of a contact lens. In particular, a low water contact angle corresponds to more wettable surface. Average contact angles (Sessile Drop) of contact lenses are measured using a VCA 2500 XE contact angle measurement device from AST, Inc., located in Boston, Massachusetts. This equipment is capable of measuring advancing contact angles (θₐ) or receding contact angles (θᵣ) or sessile (static) contact angles. Unless specified, water contact angle is sessile (static) contact angle on the anterior surface of a contact lens. The measurements are performed on fully hydrated contact lenses and immediately after blot-drying. The blot-dried lens is then mounted on the contact angle measurement pedestal with the anterior surface up, and the sessile drop contact angle is automatically measured using the software provided by the manufacturer. The deionized water (ultra pure) used for measuring the water contact angle has a resistivity >18MΩcm and the droplet volume used is 2 μl. The tweezers and the pedestal are washed well with Isopropanol and rinsed with DI water before coming in contact with the contact lenses. Each static water contact angle is the average of the left and right water contact angles. The static water contact angle in reference to a contact lens is an average water contact angle obtained by averaging the static water contact angles measured with at least 5 contact lenses.

### Water Break-up Time (WBUT) Tests

The surface hydrophilicity of lenses (after autoclave) is assessed by determining the time required for the water film to start breaking on the lens surface. Lenses exhibiting WBUT ≥5 seconds are considered to have a hydrophilic surface and are expected to exhibit adequate wettability (ability to support the tear film) on-eye.

Lenses are prepared for water breakup measurement by removing the lens from its blister (or containiner) with soft plastic tweezers (Menicon) and placing the lens in a beaker containing phosphate buffered saline. The beaker contains at least 20 mL phosphate buffered saline per lens, with up to 3 lenses per beaker. Lenses are soaked for a minimum 30 minutes up to 24 hours before being transferred with soft plastic tweezers into a 96 well plastic tray with fresh phosphate buffered saline.

Water breakup time is measured at room temperature as follows: lenses are picked up with soft plastic tweezers as close to the edge of the lens as possible, base curve toward the measurer, taking care that the lens does not touch the sides of the well after being removed from the saline. As illustrated schematically in FIG. 1, the lens (101) is shaken once to remove excess saline and a timer is started. Ideally, the water film (120) in the base curve surface of the lens will recede from the point of contact with the tweezers's tips (111) in a uniform, circular pattern (125). When approximately 30% of the hydrated area (125) has receded, the timer is stopped and this time is recorded as the water breakup time (WBUT). Lenses that do not display the ideal receding pattern can be placed back in the tray and re-measured, after rehydrating for at least 30 seconds.

### Equilibrium Water Content

The equilibrium water content (EWC) of contact lenses are determined as follows. Amount of water (expressed as percent by weight) present in a hydrated hydrogel contact lens, which is fully equilibrated in saline solution, is determined at room temperature. Quickly stack the lenses, and transfer the lens stack to the aluminum pan on the analytical balance after blotting lens in a cloth. The number of lenses for each sample pan is typically five (5). Record the pan plus hydrated weight of the lenses. Cover the pan with aluminum foil. Place pans in a laboratory oven at 100±2° C. to dry for 16-18 hours. Remove pan plus lenses from the oven and cool in a desiccator for at least 30 minutes. Remove a single pan from the desiccator, and discard the aluminum foil. Weigh the pan plus dried lens sample on an analytical balance. Repeat for all pans. The wet and dry weight of the lens samples can be calculated by subtracting the weight of the empty weigh pan.

### Elastic Modulus

The elastic modulus of a contact lens is determined using a MTS insight instrument. The contact lens is first cut into a 3.12 mm wide strip using Precision Concept two stage cutter. Five thickness values are measured within 6.5 mm gauge length. The strip is mounted on the instrument grips and submerged in PBS (phosphate buffered saline) with the temperature controlled at 21±2° C. Typically 5N Load cell is used for the test. Constant force and speed is applied to the sample until the sample breaks. Force and displacement data are collected by the TestWorks software. The elastic modulus value is calculated by the TestWorks software which is the slope or tangent of the stress vs. strain curve near zero elongation, in the elastic deformation region.

### Transmittance

Contact lenses are manually placed into a specially fabricated sample holder or the like which can maintain the shape of the lens as it would be when placing onto eye. This holder is then submerged into a 1 cm path-length quartz cell containing phosphate buffered saline (PBS, PH˜7.0-7.4) as the reference. A UV/visible spectrpohotmeter, such as, Varian Cary 3E UV-Visible Spectrophotometer with a LabSphere DRA-CA-302 beam splitter or the like, can be used in this measurement. Percent transmission spectra are collected at a wavelength range of 250-800 nm with % T values collected at 0.5 nm intervals. This data is transposed onto an Excel spreadsheet and used to determine if the lenses conform to Class 1 UV absorbance. Transmittance is calculated using the following equations:

$$UVA \% T = Average \% Transmission between 315 nm and 380 nm \times 100$$

$$UVB \% T = Average \% Transmission between 280 nm and 315 nm \times 100$$

$$Violet \% T = Average \% Transmission between 380 nm and 440 nm \times 100.$$

### Chemicals

The following abbreviations are used in the following examples: UPW represents ultra pure water having a resistivity >18MΩcm; UPLC represents ultra performance liquid chromatography; NVP represents N-vinylpyrrolidone; MMA represents methyl methacrylate; TEGDMA represent triethyleneglycol dimethacrylate; VAZO 64 represents 2,2′-dimethyl-2,2′azodipropiononitrile; Nobloc is 2-[3-(2H-Benzotriazol-2-yl)-4-hydroxyphenyl]ethyl methacrylate from Aldrich; UV28 represents 2-{2′-Hydroxy-3′-tert-butyl-5′-[3′-methacryloyloxypropoxy]phenyl}-5-chloro-2H-benzotriazole; RB247 is Reactive Blue 247; TAA represents tert-amyl alcohol; PrOH represents 1-propanol; IPA represents isopropanol; PB represents a phosphate buffered solution which has a pH of 7.2±0.2 at 25° C. and contains about 0.077 wt. % NaH₂PO₄·H₂O, about 0.31 wt. % Na₂HPO₄·2H₂O; PPh3 represents triphenyl phosphine; PBS represents a phosphate-buffered saline which has a pH of 7.2±0.2 at 25° C. and contains about 0.077 wt. % NaH₂PO₄·H₂O, about 0.31 wt. % Na₂HPO₄·2H₂O, and about 0.77wt. % NaCl and; wt. % represents weight percent; D9 represents monobutyl-terminated monomethacryloxypropyl-terminated polydimethylsiloxane (Mw˜984 g/mol from Shin-Etsu); “G4” macromer represents a di-methacryloyloxypropyl-terminated polysiloxane (Mn˜13.5K g/mol, OH content˜1.8 meq/g) of formula (A).

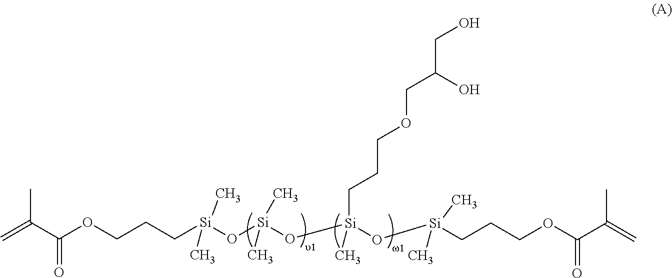

### Example 2

### Preparation of Reactive Dye

A reactive dye is prepared according to the procedures shown in FIG. 1 in which R₁ is CH₃, L₁ is ethylene divalent radical, Q₁ is OH, R₂ is Cl, X₁ is O. Compound [4] is obtained from EVERLIGHT, 2,4,6-trichloro-1,3,5-triazine are obtained from Sigma-Aldrich.

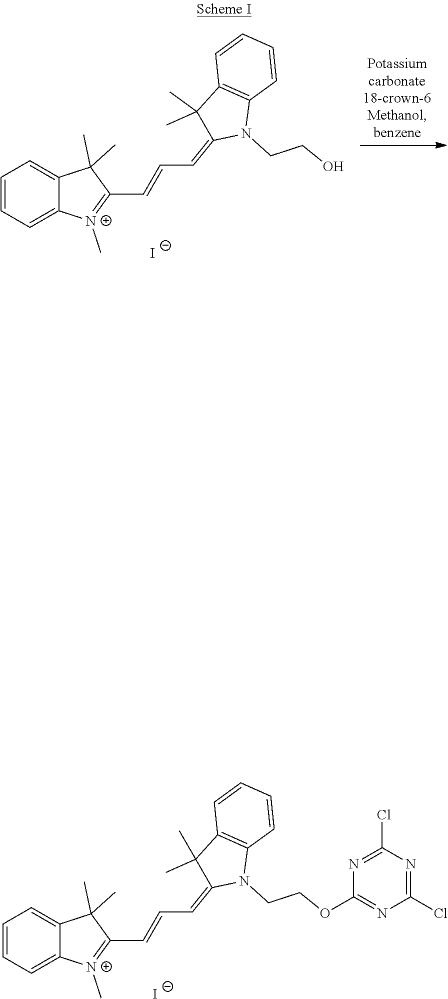 [SMILES: C[N+]1=C(/C=C/C=C2/N(CCO)c3ccccc3C2(C)C)C(C)(C)c2ccccc21 ; [I-] ; C[N+]1=C(/C=C/C=C2/N(CCOc3nc(Cl)nc(Cl)n3)c3ccccc3C2(C)C)C(C)(C)c2ccccc21 ; [I-]]

### Example 3

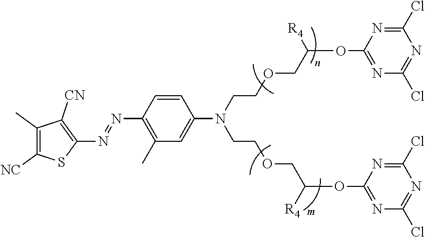

### Preparations of Reactive Dyes

A reactive dye is prepared according to the procedures shown in FIG. 2 in which R₁ is CH₃, L₂ is ethylene divalent radical, R₄ is H, R₈ is a monovalent radical of

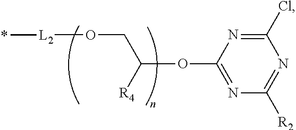

R₂ is Cl. Compound is obtained from EVERLIGHT, 2,4,6-trichloro-1,3,5-triazine are obtained from Sigma-Aldrich.

### Example 4

### Preparations of Reactive Solutions

A reactive solution (RS1) including 1.5% by weight of the reactive dye prepared in Example 2 is prepared by dissolveing the reactive dye in propanol. The pH of the aqueous reactive solution is not adjusted.

A second reactive solution (RS2) including 1.5% by weight of the reactive dye prepared in Example 3 is prepared by dissolveing the reactive dye in propanol. The pH of the aqueous reactive solution is not adjusted.

### Preparations of Alkaline Solution

An alkaline solution including 0.5% by weight of K₂CO₃ is prepared by dissolveing K₂CO₃ in water and has a pH of about 11.0.

### Preparation of Polymerizable Compositions

A SiHy lens formulation (polymerizable composition) is prepared to have the following composition (in unit parts): D9 (33); G4 (10); NVP (46); MMA (10); TEGDMA (0.65); Norbloc (1.5); UV28 (0.4); VAZO 64 (0.5); RB247 (0.01); TAA (10) as shown in Table 1.

The formulation is prepared by adding listed components in their targeted amounts into a clean bottle, with a stir bar to mix at 600 rpm for 30 minutes at room temperature. After all the solid is dissolved, a filtration of the formulation is carried out by using 2.7 μm glass-microfiber-filter.

### Preparation of Centrally Colored SiHy Contact Lenses

A lens formulation prepared above is purged with nitrogen at room temperature for 30 to 35 minutes. The N₂-purged lens formulation is introduced into polypropylene molds and thermally cured in an oven under the following curing conditions: ramp from room temperature to 55° C. at a ramp rate of about 7° C./minute; holding at 55° C. for about 30 minutes; ramp from 55° C. to 80° C. at a ramp rate of about 7° C./minute; holding at 80° C. for about 120 minutes; ramp from 80° C. to 100° C. at a ramp rate of about 7° C./minute; and holding at 100° C. for about 30minutes.

Lens molds are mechanically opened by using a demolding machine with a push pin. Lenses are pushed onto base curve molds with a push pin and then molds are separated into base curve (male) mold halves and front curve (female) mold halves with the molded contact lenses each adhered onto one front curve (female) mold half.

About 40 μL of a reactive solution prepared above is dispensed onto a molded (unprocessed) contact lens adhered on a front curve mold half in its central circular region.

It then is placed in a vacuum oven at 75° C. for 90 minutes to dry the unprocessed contact lens. The dried unprocessed contact lens is mechanically separated (delensed) from the front curve mold half, followed by rinsing it with DI water for 5 minutes, immersing it in a seried of baths: an alkaline solution prepared above at 75° C. for 30 minutes, DI water for 5 minutes, 50/50 PrOH/H₂O for 30 minutes, PrOH for 30 minutes, PB for 5 minutes for 2 times, and finally packaged and autoclaved at 121° C. for 45 minutes in individual lens packages containing PBS obtain centrally colored SiHy contact lenses.

All the publications and patents which have been cited herein above are hereby incorporated by reference in their entireties.

1. A reactive dye of any one of formulation (1), (2) and (3) 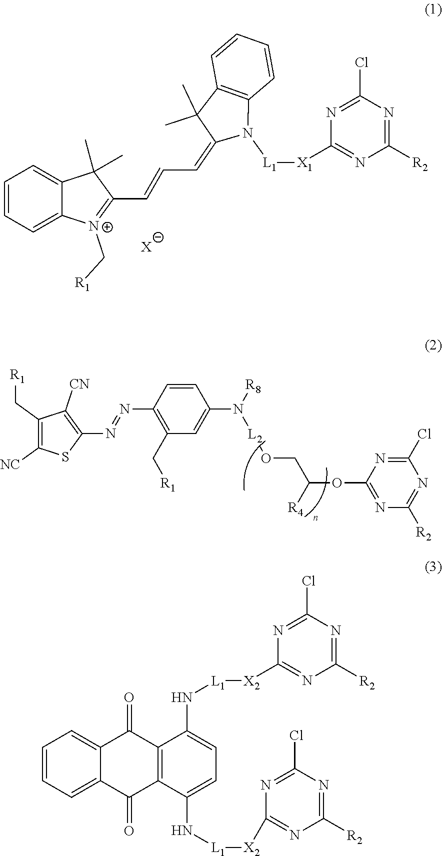
in which: X⁻ is a negatively-charged counter ion (preferably I, Br, Cl, R₃COO⁻, R₃SO₃⁻ or Bis(oxalate)borate) or a negatively charged group of R₁; R₁ is H or a C₁-C₁₀ alkyl which is optionally substituted with one or more functional groups selected from the group consisting of OH, OCH₃, OC₂H₅, COOH, COOR₅, NR₆R₇, SO₃⁻, and combinations thereof (preferably H); R₂ is H or Cl (preferably Cl); R₄ is H or CH₃; R₃ and R₅ independent of each other are a C₁-C₄ alkyl; R₆ and R₇ independent of each other are H or a C₁-C₄ alkyl; L₁ is a C₂-C₁₀ alkylene divalent radical or a divalent radical of 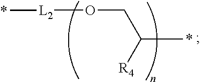
L₂ independent of each other are a C₂-C₁₀ alkylene divalent radical; R₈ is a C₁-C₁₀ alkyl which is optional substituted with one or more functional groups selected from the group consisting of OH, OCH₃, OC₂H₅, COOH, COOR₅, NR₆R₇, SO₃⁻, and combinations thereof or is a monovalent radical of 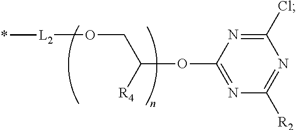
X₁ is 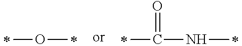
in which the nitrogen atom is connected to triazine; X₂ is 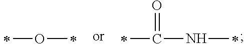
and n and m independent of each other are an integer of 1 to 10.

2. The reactive dye of claim 1, wherein R₂ is Cl.

3. The reactive dye of claim 1, wherein R₁ is H.

4. The reactive dye of claim 1, wherein R₁ is a C₁-C₁₀ alkyl which is optionally substituted with one or more functional groups selected from the group consisting of OH, OCH₃, OC₂H₅, COOH, COOR₅, NR₆R₇, SO₃⁻, and combinations thereof.

5. The reactive dye of claim 1, wherein the reactive dye is defined by formula (1).

6. The reactive dye of claim 5, wherein in formula (1) L₁ is a C₂-C₁₀ alkylene divalent radical.

7. The reactive dye of claim 5, wherein in formula (1) L₁ is a divalent radical of 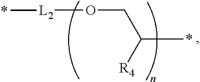
n is an integer of 1 to 10.

8. The reactive dye of claim 5, wherein in formula (1) X₁ is is *—O—*.

9. The reactive dye of claim 5, wherein in formula (1) X₁ is 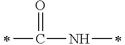
in which the nitrogen atom is connected to triazine.

10. The reactive dye of claim 1, wherein the reactive dye is defined by formula (2).

11. The reactive dye of claim 10, wherein in formula (2) R₈ is a C₁-C₁₀ alkyl which is optional substituted with one or more functional groups selected from the group consisting of OH, OCH₃, OC₂H₅, COOH, COOR₅, NR₆R₇, SO₃⁻, and combinations thereof.

12. The reactive dye of claim 10, wherein in formula (2) R₈ is a monovalent radical of

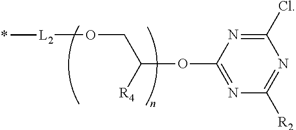

13. The reactive dye of claim 12, wherein in formula (2) n is an integer of 1 to 10.

14. The reactive dye of claim 12, wherein in formula (2) n is zero.

15. The reactive dye of claim 1, wherein the reactive dye is defined by formula (3).

16. The reactive dye of claim 15, wherein in formula (3) L₁ is a C₂-C₁₀ alkylene divalent radical.

17. The reactive dye of claim 15, wherein in formula (3) L₁ is a divalent radical of 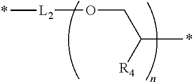
and n is an integer of 1 to 10.

18. The reactive dye of claim 15, wherein in formula (3) X₂ is is *—O—*.

19. The reactive dye of claim 15, wherein in formula (3) X₂ is

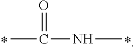

20. A method for producing colored silicone hydrogel contact lenses, comprising the steps of:
(1) obtaining a polymerizable fluid composition comprising
(a) at least one silicone-containing vinylic monomer optionally having at least one hydroxyl group and/or at least one polysiloxane vinylic crosslinker optionally having at least one hydroxyl group,
(b) at least one hydrophilic vinylic monomer,
(c) at least one hydroxyl-containing polymerizable material selected from the group consisting of said at least one silicone-containing vinylic monomer having at least one hydroxyl group, said at least one polysiloxane vinylic crosslinker having at least one hydroxyl group, a non-silicone hydroxyl-containing vinylic monomer, and combinations thereof,
(d) optionally at least one component selected from the group consisting of a non-silicone vinylic crosslinker, a non-silicone hydrophobic vinylic monomer, a UV-absorbing vinylic monomer, a HEVL-absorbing vinylic monomer, and combinations thereof, and
(e) at least one first free-radical initiator;
(2) introducing the polymerizable fluid composition into a lens mold, wherein the lens mold comprises a male mold half having a first molding surface and a female mold half having a second molding surface, wherein the male and female mold halves are configured to receive each other such that a mold cavity is formed between the first and second molding surfaces and the polymerizable fluid composition is enclosed in the mold cavity when the mold is closed;
(3) curing thermally or actinically the polymerizable fluid composition in the mold cavity of the lens mold to form a contact lens precursor having a crosslinked polymer network with hydroxyl groups covalently attached thereto;
(4) separating the lens mold into the male and female mold halves, with the contact lens precursor adhered onto the female mold half;
(5) applying a reactive solution onto an area in a central circular region on the surface of the contact lens precursor adhered on the female mold half, wherein the reactive solution comprises a reactive dye of claim 1 and at least one organic solvent miscible with water and has a pH of about 8.0 or lower, wherein the central circular region has a diameter of about 13 mm or less and is concentric with the central axis of the contact lens precursor;
(6) after the reactive solution has penetrated and diffused into the crosslinked polymer network, drying the contact lens precursor adhered onto the female mold half to obtain a dried contact lens precursor with the reactive dye distributed in the central circular region;
(7) removing the dried contact lens precursor from the female mold half;
(8) optionally rinsing the dried contact lens precursor obtained in step (7) with water to obtain a hydrated contact lens precursor containing the reactive dye distributed in the central circular region;
(9) immersing the dried contact lens precursor obtained in step (7) or the hydrated contact lens precursor obtained in step (8) in an alkaline aqueous solution at a temperature from about 50° C. to about 90° C. for a time sufficient for covalently attaching the reactive dye to the crosslinked polymer matrix to obtain a centrally colored contact lens; and
(10) subjecting the centrally colored contact lens obtained in step (9) to at least one of post-molding processes selected from the group consisting of hydration, extraction, surface treatment, packaging, sterilization (autoclaving), and combinations thereof.

21. A colored silicone hydrogel contact lens, comprising (1) a polymer matrix having hydroxyl groups covalently attached thereonto; and (2) a colored annular ring and/or a colored central circular area both of which are located in a central circular region of the colored silicone hydrogel contact lens, wherein the central circular region has a diameter of about 9.0 mm or less (preferably about 8.5 mm or less, more preferably about 8.0 mm or less, even more preferably about 7.5 mm or less) wherein the colored annular ring and the colored central circular area independent of each other comprise at least one reactive dye of claim 1 which is covalently attached onto the polymeri matrix through linkages formed between one hydroxyl group and a dichlorotriazine or chlorotriazine of the reactive dye, wherein the colored annular ring and the colored circular area are concentric with the central axis of the colored silicone hydrogel contact lens.
